(19) United States
(12) Patent Application Publication
(10) Pub. No.: US 2007/0143215 A1
(43) Pub. Date: Jun. 21, 2007

(54) Device, system and method for storing and exchanging medical data

(76) Inventor: Serge Clement Damien Willems, Nijmegen (NL)

Correspondence Address: GREENLEE WINNER AND SULLIVAN P C, 4875 PEARL EAST CIRCLE, SUITE 200, BOULDER, CO, 80301, US

(21) Appl. No.: 10/588,520

(22) PCT Filed: Feb. 7, 2005
(86) PCT No.: PCT/NL05/00091

§ 371 Date: Feb. 23, 2007

(30) Foreign Application Priority Data
Feb. 6, 2004 (NL) 1025436

(51) Int. Cl. G06Q 50/00

(52) U.S. Cl. 705/51; 705/3

(57) ABSTRACT

The present invention relates to a system for storing and exchanging medical data, the system comprising: —a plurality of portable electronic storage devices, each storage device comprising an interface and one or more data carriers on which are stored medical data representative of the health of at least one individual and a computer program; —a data processing device comprising: —a second interface for connecting the data processing device to at least one of the portable electronic storage devices, —a processor configured so as to load from the connected portable electronic storage device the computer program and executing the same, the loaded computer program including instructions that cause the processor to process the medical data stored on the portable storage device, said processing including reading, adding and/or modifying medical data stored on the connected portable electronic storage device; —a display device for displaying said processed medical data.

The present invention relates to a portable electronic storage device, a system and a method for storing and exchanging medical data.

Patients need confidentiality and privacy. This need is so strong that there are even laws such as the privacy law, and healthcare professionals are obliged to swear their oath of office. These laws and obligations ensure that patients (including users in general) have and want to have a strong control in who may know what about their own health status. On the other hand, patients want a care provider to supply a good and fast diagnosis. The pressure to produce a good and fast diagnosis is high because the patient mostly wants to start as soon as possible with the correct treatment.

For a good diagnosis, exactly the right amount of information is required. In case of too much information, available essential information may be missed. In case of too little information, essential information might not be present. The patient decides which information he or she gives to the healthcare professional, but the patient is not always sure whether the information given is sufficient and describes exactly the right picture. The patient does not always give all the information necessary for a good diagnosis. This happens easily when the patient is either ashamed of this information or when this information is old and presumed not important.

If the patient gives information which involves other healthcare professionals, the professional wants to check the integrity and completeness of the given medical information by consulting those other professionals, before continuing the diagnosis or treatment. This also takes time and correspondence. The given response is not always as expected and mistakes in this communication are very difficult to check.

Because of the above-discussed social situation, it has been proven very difficult to set up a central (e.g. national) database that can track, protect and maintain all medical data from all patients. Consequence to this is that healthcare professionals collect and store the data of patients, resulting the situation that information of each patient is fragmented over multiple healthcare professionals and the medical records may even be distributed over multiple locations.

The wish for organized and accessible medical data was the reason why software was developed to maintain a medical database on a personal computer or laptop. The advantage of this software is that medical data on one disease of one person is complete. In practice, this solution has resulted in lack of compatibility with the different computer systems of the individual healthcare professionals.

Internet sites exist where patients can enter their medical data so that each healthcare professional, with the right authorisation, can look at these data. The problem here is that the patients have to enter the medical data themselves, therefore the medical integrity of the data cannot be guaranteed. Besides this, this system requires not only a computer but also an Internet connection from the healthcare professional. Additional to this, the data is less safe, because anybody can anonymously try to access the personal medical data, even multiple times.

Additionally, many patients do not want their files passed on by means of Internet or e-mail. Non-authorised passage of their medical files is relatively too easy, and the disorder concerning security of Internet use is contrary to the requirement of confidentiality of medical information. Furthermore, patients and healthcare professionals remain concerned about the security of data on Internet. There are many examples of leaks of sensitive data, because of insufficient security. A large database of medical information attracts hackers, criminals or even terrorists. If a medical database is used for sharing information, important for diagnoses and treatments, the contents of these data must be complete and accurate; until now this can not be guaranteed.

In order to overcome the drawbacks of keeping sensitive medical data on a remote Internet servers, systems have been developed wherein medical dossiers are kept in portable electronic devices. Examples of existing systems and methods for using portable medical dossiers are described in the patents U.S. Pat. No. 5,899,998 by McGauly, U.S. Pat. No. 5,499,293 by Behram et al., U.S. Pat. No. 6,082,776 by Feinberg and U.S. Pat. No. 2,003,088,440 by Dunn B. Rentz.

One of the drawbacks of the known systems is that the electronic device carried by the patient only contains the medical data of the patient. One of the implications is that the medical data is only accessible by people and institutions that have at their disposal the specific physical interfaces and the specific software needed to access these data. The portability is strongly reduced by this restriction.

Another drawback is that the known systems provide for the storage of data for medical use only. However, it can be of vital importance to be fully aware of a patient's general health condition during treatment. Information such as weight, drug use, diabetes etc. might be useful in the assessment of the general health condition of the patient.

A further drawback of the prior systems is that possible lifesaving functionality is missing. If, for instance, a patient is unable to give user and password information, the emergency healthcare professionals and ambulance personnel may not be able to read the stored information that can be vital and crucial for emergency treatment of the patient.

It is therefore an object of the present invention to provide a system, device and method wherein at least one of the drawbacks of the prior art is obviated.

According to a first aspect of the present invention a system is provided for storing and exchanging medical data, the system comprising:
a plurality of portable electronic storage devices, each storage device comprising an interface and one or more data carriers on which are stored medical data representative of the health of at least one individual and a computer program;
a data processing device comprising:
a second interface for connecting the data processing device to at least one of the portable electronic storage devices,
a processor configured so as to load from the connected portable electronic storage device the computer program and executing the same, the loaded computer program including instructions that cause the processor to process the medical data stored on the portable storage device, said processing including reading, adding and/or modifying medical data stored on the connected portable electronic storage device;
a display device for displaying said processed medical data.

The system reduces the chance of misdiagnosis since the medical data is more readily available to the healthcare professional. Therefore the results of misdiagnosis caused by for example interaction of different medications prescribed by different healthcare professionals, use of medications which influence other sicknesses than the one prescribed for, and medications and/or allergies not known by emergency or ambulance personnel can be avoided. Furthermore, the system enables a quicker diagnosis to be made.

Another benefit for patients may be the feedback of information, such as results of treatments, to scientists and researchers. In this way current treatment and development of new medication can be improved, and bad or insufficient treatment and medications can be stopped. Incidentally, medical data as described herein include (but are not limited to) data representative of a person's medical condition and health in general.

In a preferred embodiment the system comprises a first portable electronic storage device being configured so as to store thereon medical data in a first data format and a second portable electronic storage device being configured so as to store thereon medical data in a second data format, different from the first format.

Preferably a first computer program is stored on the first portable electronic storage device that is capable of having processed medical data in the first format, while on the second portable electronic storage device a second computer program is stored capable of having processed medical data in the second data format.

According to a further preferred embodiment the system comprises a portable electronic storage device on which is stored a first and a second computer program, the first computer program being operable so as to exchange medical data with a data processing device of a first type en the second computer program being operable so as to exchange medical data with a data processing device of a different type.

According to a further preferred embodiment access to the medical data on the electronic storage device is protected by an access code, preferably a password. In another preferred embodiment a first user or group of users has data reading rights only. In an even further preferred embodiment a second user or second group of users has reading and adding rights only. In a still further preferred embodiment a third user or third group of users has reading, adding and modifying rights of medical data stored or to be stored on the electronic storage device. The rights might be given for all medical data stored on the storage device. Preferably however the reading, adding and/or modifying rights are for a predefined subset of medical data only.

In a further preferred embodiment the computer program is operable so as to permit the addition of a new user or group of users only after receiving the correct access code of said individual. This will provide the individual, for instance the owner of the storage device, always the control over the grant of reading, adding and/or modifying rights to others.

In an even further preferred embodiment the computer program is operable so as to permit access to a predefined portion of the medical data only after receiving the correct access code of said individual. This predefined portion of the medical data can in this case only be accessed by the individual or by a third party to which the individual has provided an access code.

In an especially preferred embodiment the processing device is a mobile phone and the electronic storage device is an external storage medium that can be connected to the mobile phone or, in another embodiment, the processing device is a mobile phone and the electronic storage device is an internal storage medium contained in the mobile phone. Both embodiments have the advantage that the medical data is stored in an electronic device that nowadays a large part of the population keeps has close at hand. Furthermore, use can be made of the processor and display device available in the mobile phone to respectively process and display the medical data.

In another embodiment, however, the data processing device is a personal computer, for example a personal computer, stand alone computer, server, laptop, palmtop, handheld, or PDA.

In still another preferred embodiment the electronic storage device is configured so as to be implanted in a person. In the implanted device both the software and the data are stored as well. Data exchange to and from the implanted storage device is wireless, for example using a radiofrequency transceiver.

In another preferred embodiment the electronic storage device comprises a positioning system. Whenever necessary the patient can be traced by the positioning system, for example a GPS or Galileo module. When the person is traced and found, immediate medical help can be given if necessary, with the medical/health data stored in the electronic storage device.

The interfaces of the data processing device and the portable electronic storage device may be wireless communication devices to provide a wireless connection between the portable electronic storage device and the data processing device or may be wired communication devices to provide a wired connection between the portable electronic storage device and the data processing device.

According to a preferred embodiment the computer program is operable so as to provide text on the display device in one of a plurality of languages, said one language being user selected from a pre-stored list of languages.

According to another aspect of the invention a portable electronic storage device is provided for storing and exchanging medical data with a data processing device having an interface, a processor and a display device, wherein the portable electronic storage device comprises a data carrier on which is stored medical data representative of the health of at least one individual and a computer program, wherein the computer program, when run on said processor, causes said processor to process the medical data stored on the data carrier, said processing including reading, adding and/or modifying medical data stored on the connected portable electronic storage device, and displaying said processed data on the display device.

Further advantages, features and details of the present invention will be elucidated on the basis of the following description of a preferred embodiment of the invention. In the description reference is made to the accompanying drawings, in which:

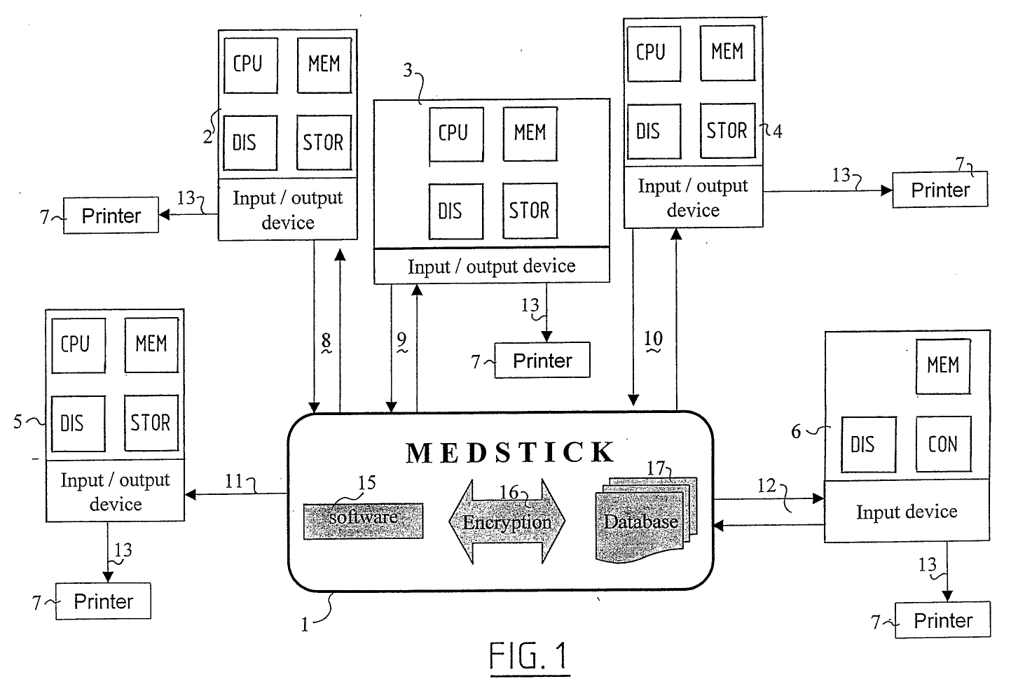

FIG. 1 is a schematic representation of a preferred embodiment of the present invention,

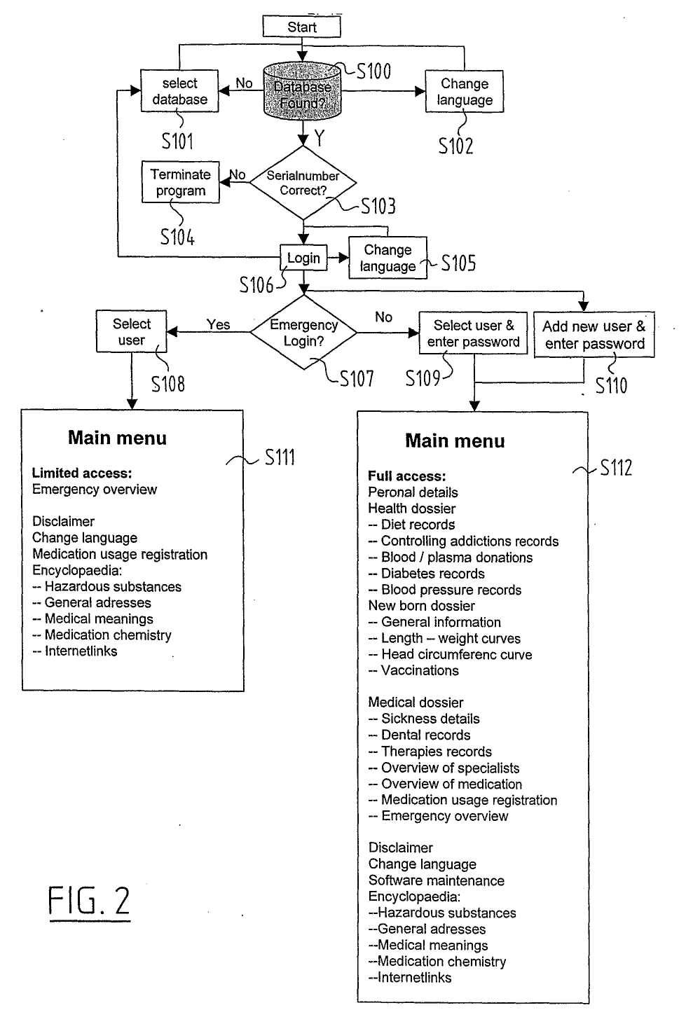

FIG. 2 is a flowchart showing the login process to enter the storage device of FIG. 1;

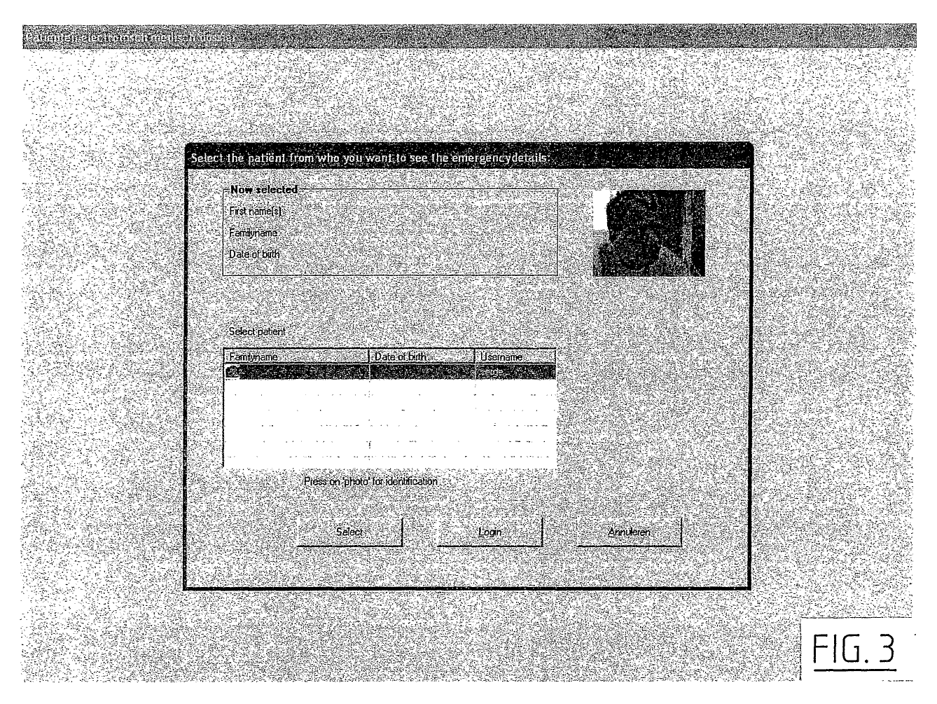

FIG. 3 is a window showing the emergency selection screen on the display of a data processing device;

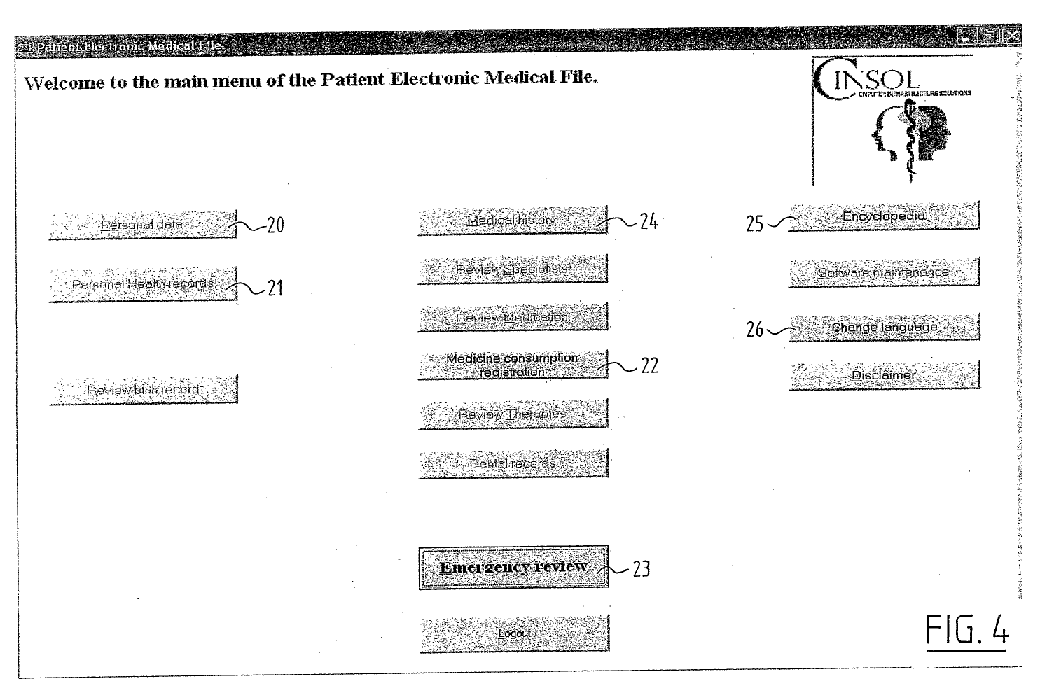

FIG. 4 shows a main menu screen;

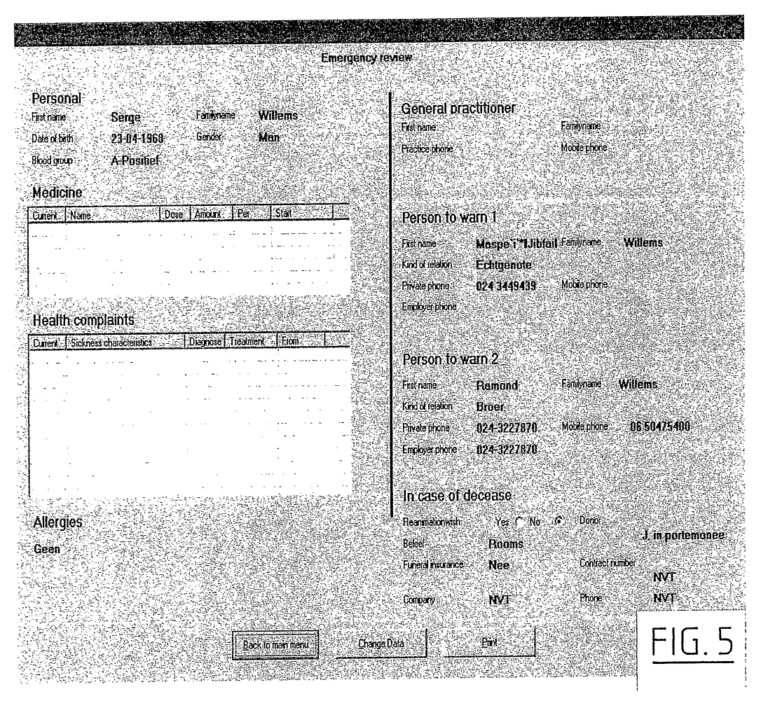

FIG. 5 shows an emergency review screen;

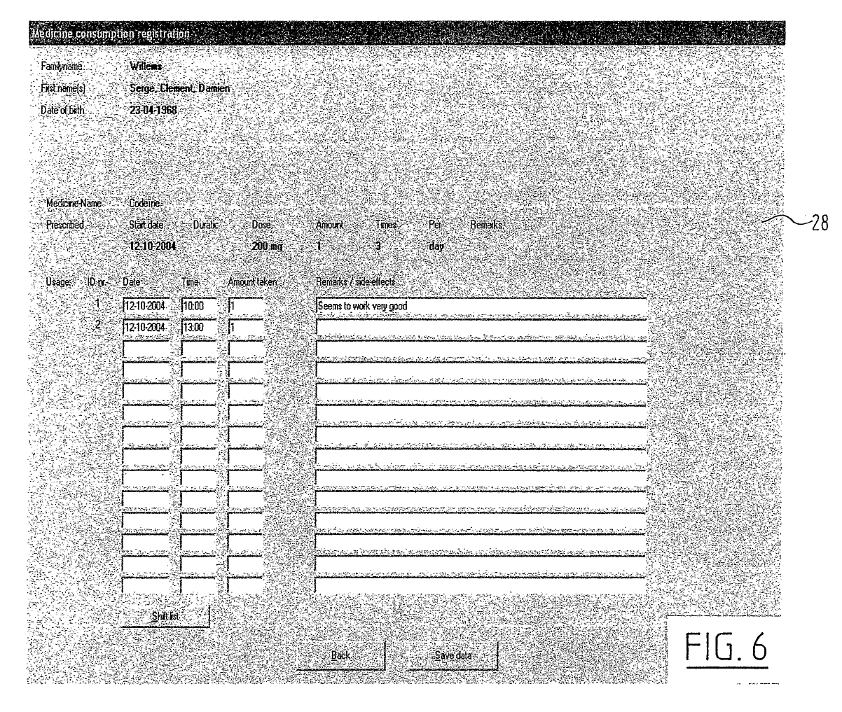

FIG. 6 shows a medication consumption registration screen;

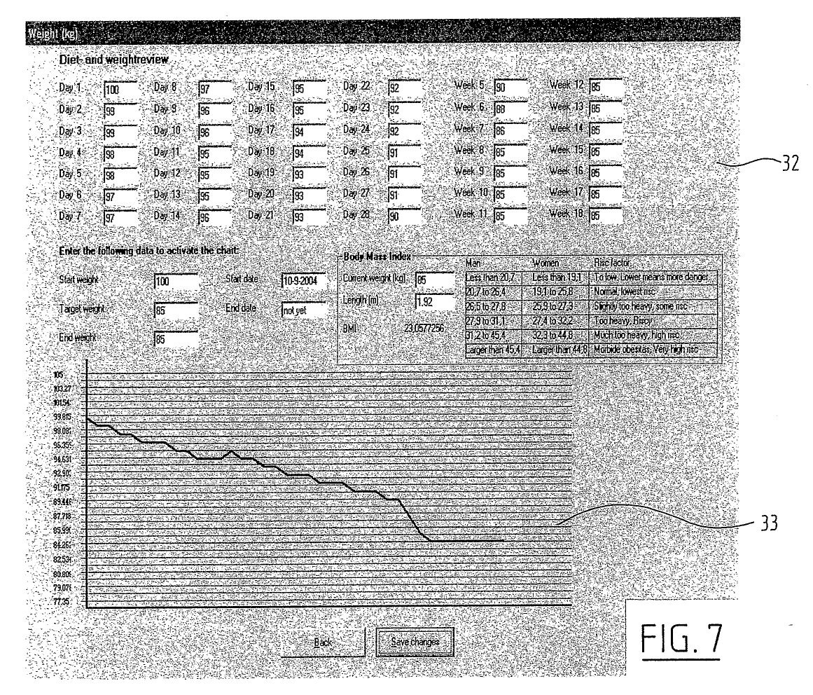

FIG. 7 shows a diet screen of a health dossier;

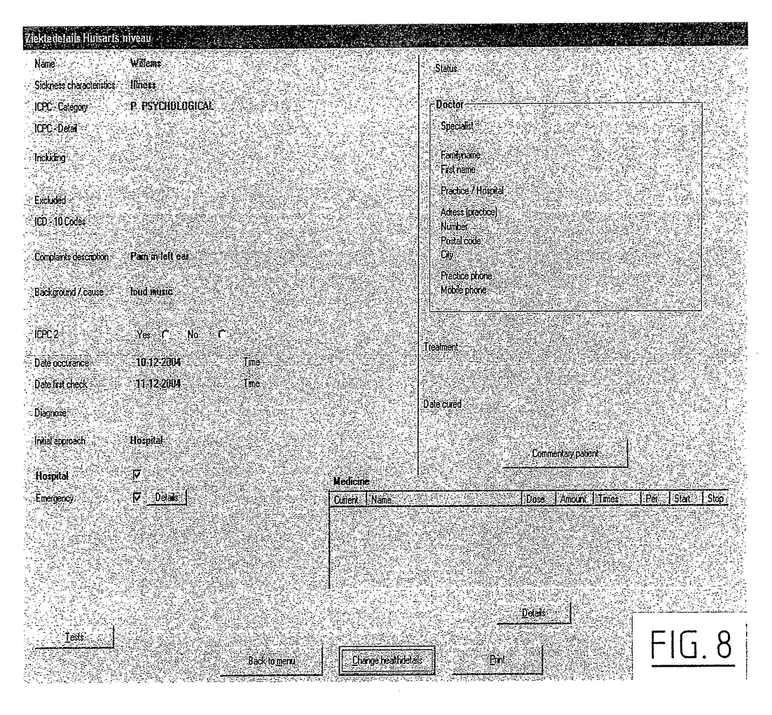

FIG. 8 shows a protected medical detail screen of a medical dossier;

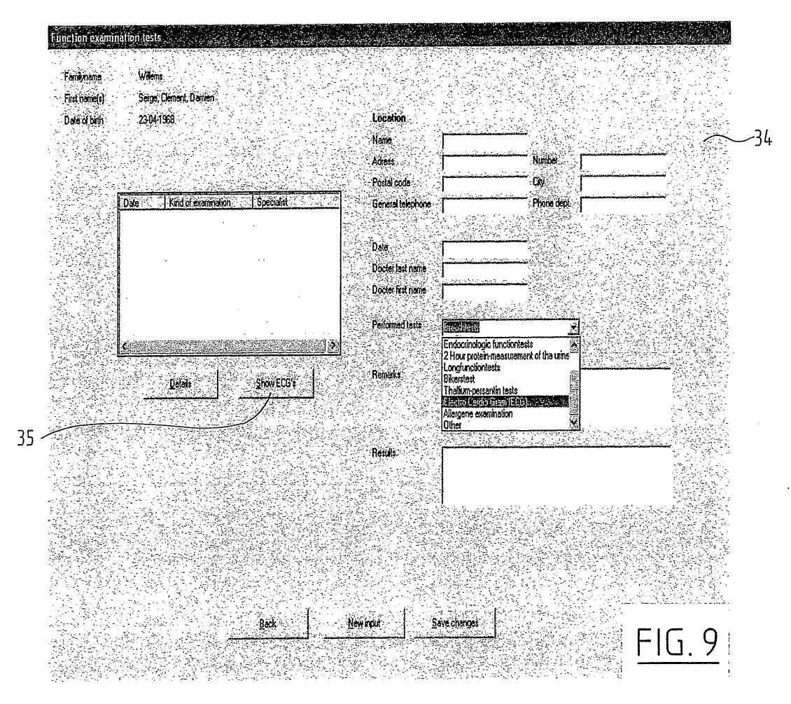

FIG. 9 shows the example of a pre-stored function examination test screen;

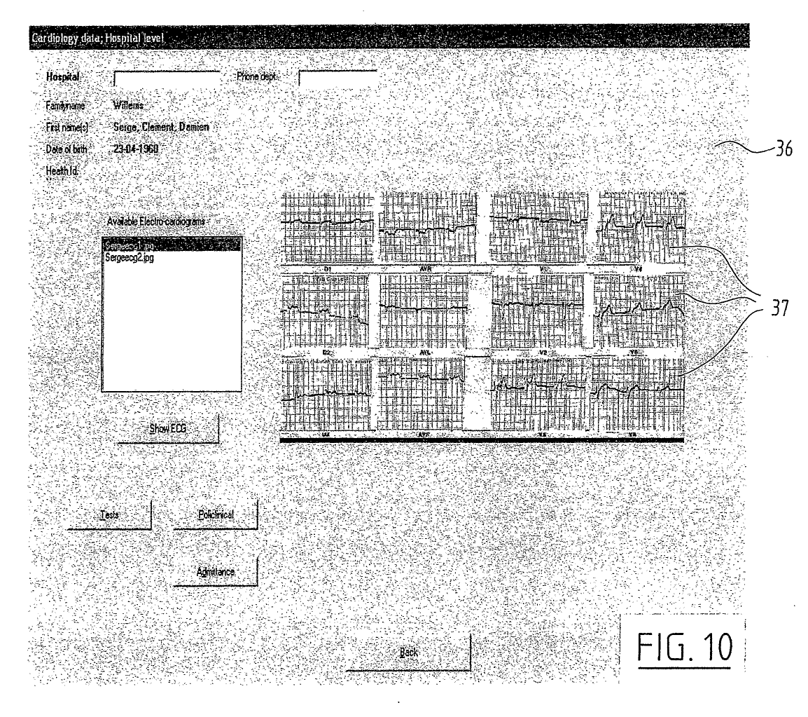

FIG. 10 shows the example of a pre-stored cardiology test screen, including pre-stored medical data;

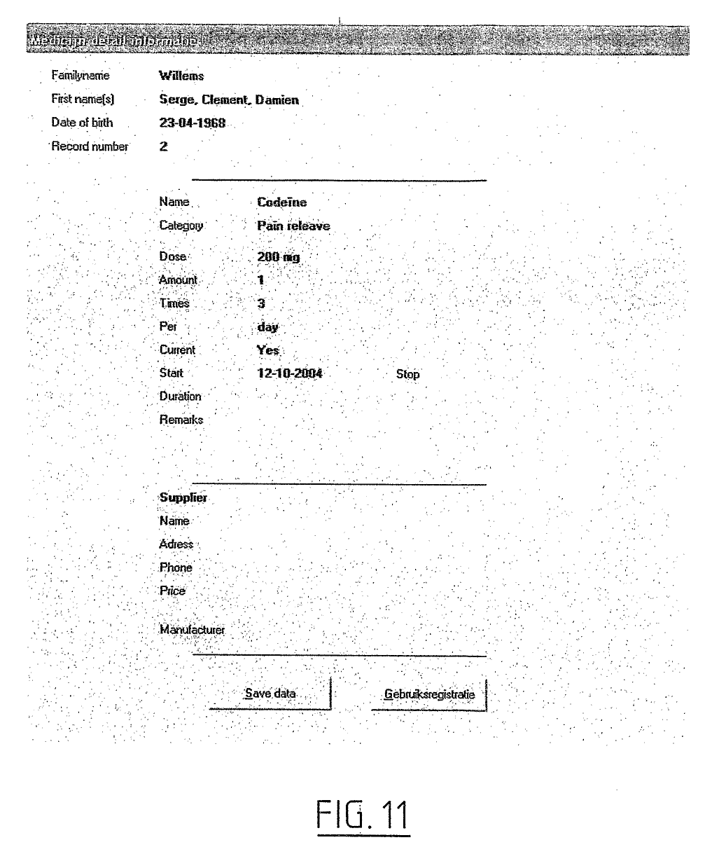

FIG. 11 shows an example of a medicine information screen; and

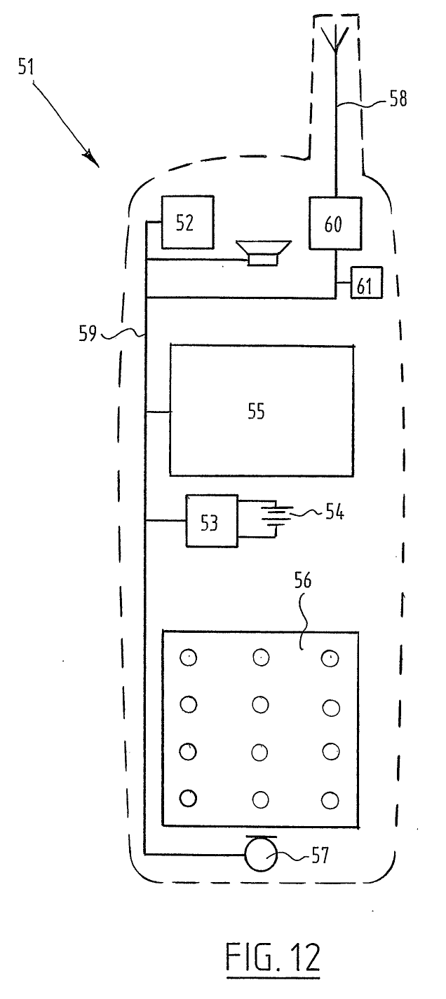

FIG. 12 is a schematic view a further embodiment of a portable electronic storage device according to the present invention.

One of the goals of the present invention is that the healthcare professional, at the moment that the healthcare professional finds it necessary, has access to the complete health status of the patient, so that the healthcare professional can choose, select and pick all the information assumed needed for a diagnosis, treatment, advice or other action.

FIG. 1 shows a first preferred embodiment of the system according to the present invention. The figure shows a portable electronic storage device 1 that can be connected (directly or wirelessly, as will be explained later) to an input/output unit (I/O) of a data processing device, for example a USB memory stick that can be inserted into the USB port of a computer. Besides the input/output unit a data processing device comprises typically a central processing unit (CPU), a memory (MEM), a data storage unit (STOR), a display (DIS), etc. To the processing devices might be connected peripherals, such as a printer 7. Examples of processing devices are personal computers (stand alone or part of a network), server computers, laptops, palmtops, PDA's and/or handheld portable phones.

The input/output unit (I/O) of a data processing device may be a wired unit using a cable, a piece of hardware, or a wireless unit using for example an infrared connection, a direct radiographic connection (Bluetooth, WiFi or the like) or a connection by satellite. It is noted that the input/output units of the data processing devices do not have to be the same or of the same type. The portable storage device comprises one or more data carriers on which the medical data and/or health data and the control program are stored.

A non-limitative list of examples of data carriers includes USB Memory sticks, Memory cards, Chip cards, Cards with magnetic strips, Interactive watches, Digital video and/or photo camera's, Palmtop/handheld, Notebook, laptops, Hard discs/mini-hard-discs, CD Rom/CD Rom writable/CD Rom rewritable, DVD, Mini disc, or an ID card with an uplink to a central database, where the patient has given authorisation for storage of his/her medical data.

FIG. 1 shows a plurality of data processing devices 2-6 of various persons and/or institutions that use the present system. Processing device 2 is the computer of a patient, processing device 3 is the computer of a healthcare professional, for instance a general practitioner, a dentist, a specialist, an infant welfare centre or a therapist, processing device 4 is the computer of a pharmacist, processing device 5 is the computer of an insurance company and processing device 6 is the mobile phone of emergency personnel. The download and upload processes 8-12 indicate the data streams between the portable storage device 1 and each of the processing devices 2-6, while data stream 13 indicates data streams from a processing device 2-6 to a peripheral device 7. The storage device comprises a database 17 containing medical and/or personal data of the user, encryption software 16 for encrypting and decrypting the data to be stored on the storage device 1 and the general software 15 responsible for handling the medical data (reading, writing and modifying the medical data and processing the same).

The software may be written in any programming language (e.g. C++, C#, Visual Basic, Java, XML, XMS and many others). The data in the database 17 may be of any type, including text, audio- and/or video data (sound fragments, photographs, pictures, X ray plots, drawings, schemes, presentations, (MRI) scans). Examples of appropriate databases are SQL, MySQL, MS Access, Oracle, MS Excel, Dbase, foxpro, Paradox, ODBC, Xbase, Lotus 1 2 3, XML, XMS, text files and user defined databases and/or files.

Once the electronic storage device 1 has been connected to any of the data processing devices 2-6 the user, i.e. the patient, the healthcare professional, the pharmacist, the insurance company, or the emergency personnel respectively, must gain access to the software and data stored on the storage device 1. To accomplish this the user has to login to the electronic storage device.

FIG. 2 shows a flowchart of a preferred login process to the electronic storage device. When the storage device 1 is connected properly to the processing device (i.e. any of the devices 2-6), the processing device loads and executes the software or parts of the software 15 stored on the storage device 1. Then the processing device looks whether a database 17 is present on the storage device 1 (step 100). If this database is not found, a dialog-box appears (step 101) on the display (DIS) of the processing device 2-6 stating that the database 17 was not found and prompting the user to specify the location of the database.

If the processing device finds the proper database, it performs a check (step 103) whether the serial number in the database matches the one found on the storage device 1. If the serial number does not match the one found, a warning goes out and the program terminates (step 104).

If the serial number does match the number found on the storage device 1, the processing device will then enter the actual login procedure (step 106) by choosing from one out of three operational modes, i.e. login in case of emergency, create a new account or login as an existing user.

If the login in case of emergency (step 107) mode is chosen, the emergency care provider will have to select the proper user (patient) by identifying both his/her name and identity photograph. To this end, the processing device shows on its display (DIS) a window including the name and a photograph of the patient, as is shown in FIG. 3. If the emergency care provider identifies the patient positively as one of the users of the portable storage device 1, the patient can be selected (step 108) which will cause the processing device to continue to the main menu (step 111). The main menu is schematically shown in FIG. 4 and contains a number of buttons 20-26. In the present operational mod some of the buttons can be activated by the user, in this case the emergency care provider, while other buttons are blocked from being activated by the user. Since the emergency care provider has only limited access rights the data in the medical database 17, it is only a small subset of the buttons that is selectable in the present operational mode. In other words, only the emergency section of the medical dossier can be activated in the present mode.

One of the buttons that can be selected in the emergency mode of operation is the “emergency review” button 23. When emergency review button 23 is activated, the processing device generates an emergency window. Only information crucial for stabilizing the patient will be made available in this window. A part of the contents of the emergency overview comes from the personal database. Another part will has been entered specifically separately. This way the patient has maximum control over which data is to be shown there and which data may not be shown. An example of a emergency window is shown in FIG. 5. The window shows the name, gender, age, blood group, list of medicines used by the patient, a list of health complaints, etc.

Additionally, emergency care providers may need to access the medication consumption registration to see if and how good medication has been taken and what the reaction of the patient was. To this end the emergency care provider can first select the “medication consumption registration” button 22. Activation of this button will cause the processing device to access the database 17 and search for information regarding the history of the consumption of particular medicines. FIG. 6 shows a window 28 displaying consumption registration data of a particular medicine. For instance, the window may show the name of the medicine (codeine), the dose, the consumption dates and times, and the side effects.

In some preferred embodiments other screens are made available by the software 15 as well, for example screens for providing access to a medical encyclopedia stored on the storage device 1 and/or screens for changing the language of the windows.

If the create a new account (step 110) operational mode is chosen, the new user is requested to enter a username, enter a password and retype the password to be sure the passwords match. If the username and the password are set, the main menu is displayed (step 112) and the new user can start adding personal or medical data.

If an existing user intends to gain access to the medical database, he or she will is requested to enter a password (step 109). If the password is correct the program continues to the main menu (step 112) and the user may start to add all information wanted in the appropriate records of the database.

Accessing the personal information field by activating the “personal details” button 20 (FIG. 4) will cause the processing device to create and display an input window in which the user, in this case the owner of the storage device 1, can add, remove or modify personal information, such as name, address, age, number of identity papers and card-data, insurances, phone numbers, addresses, etc.

Accessing the personal health page by pressing the ‘personal health records’ button 21 will cause the processing device to provide access to the database records associated with the personal health of the owner(s) of the storage device 1, such as the dossiers diet, donations, blood sugar levels, addictions and blood pressure measurements, as will be explained hereafter.

FIG. 7 shows the personal diet window 32 wherein the user can enter information about his weight (start weight and target weight, weights measured in a predefined time interval). Based on the entered information the processing device generates a chart 33 wherein the measured weights are depicted as function of time. In another dossier (not shown), measured blood sugar levels are entered and stored in the database 17. The processing device is able to generate a number of graphs, each showing the measured blood sugar levels as function of the time of day. When two or more graphs showing the measured blood sugar levels on different days are displayed simultaneously, they may be compared easily to obtain a better understanding of the course of the blood sugar level in time.

Accessing the medical dossiers by pressing the “medical history” button 24 will give access to a plurality of medical dossiers associated with the owner or owners of the portable storage device 1. Firstly of all the processing device checks which medical records are present in the database 17, generates a list of available medical records and displays the list in a medical record selection window on the display (DIS). After selecting a particular medical record, a first window pertaining to the selected medical record is shown on the display of the processing device. FIG. 8 shows an example if a first window of a medical record provided (and owned) by the general practitioner. The content of this medical record is protected by username and password of the general practitioner. In succession, the general practitioner can take a few possible actions:
Do nothing/give advise
Give medication
Perform some tests or let others perform tests
Refer to medical specialists

In case the general practitioner does nothing or gives advice, this can be stored in the current record. No other field is required. In case the general practitioner wants to give medication, a further screen (window) appears, wherein the general practitioner can add the medicine prescribed, the amount, how many times a day, how many days etc. The general practitioner can also choose a medication from a list of medications, the list being imported from a pre-stored list of available medicines from database 17 on the portable storage device 1. In case the general practitioner wants to perform some test, a further screen (window) appears wherein the practitioner can choose from a list of tests, the list being imported to the processing device from a pre-stored list of available (standard) tests from the database 17 on the portable storage device 1. The present screen is the same screen as a specialist doctor will see when a specialist wants to perform some tests. The general practitioner (or the specialist) may for example choose from the following tests:
Endoscopic test;
Function examination;
Laboratory;
Microbiological;
Nucleair examination; and
X-ray.

FIG. 9 shows an example of a window 34 that is generated by the processing device wherein the results of one or more function examination tests can be filed. The processing device generates the window 34 based on a standard format pre-stored on the storage device 1. The format is pre-stored on the storage device 1 in order to provide general practitioners (or specialists) for each function examination test with a data input (and/or output) window having a uniform layout. Window 34 includes a button 35, at the activation whereof a further window 36 is displayed. The further window 36 (FIG. 11) shows a number of charts 37, in the present case Electro Cardiograms and Electro Encephalic grams.

The general practitioner may refer a patient to a hospital or a clinic to obtain more specialised research, treatment and care. In this case, information that is more specific will be more useful. First the new owner of the record (i.e. the specialist in the hospital) has to set his or her password for the new record. Some data are already available to the specialist while these data is inherited from the general practitioner's record. For example, the name, address, date of birth, telephone numbers are inherited from the personal dossier of the user(s). Other data or more specific details are still to be entered. Some examples of standard format medical dossiers are emergency, internal healthcare, plastic surgery, intensive care, cardiology, etc. Incidentally, the medical dossiers are designed as template and may therefore be easily adapted to the hospital's or individual healthcare provider's needs. When medical records are created, information about the healthcare providers involved in the treatment of a certain individual user and/or about the medications taken by the individual user becomes available. These two groups can be sorted out to give an overview. In this way another specialist or the individual user can view a list of the specialists involved or all medications given. FIG. 11 gives an example of a window 40 to be shown on the display (DIS) of the processing device. The window shows information about the medicine “codeine” used by patient. Pressing button 41 on window 40 can activate the earlier described window 28 displaying consumption registration data the present medicine (cf. FIG. 6). In this way information about the actual consumption of the medicine (consumption dates and times, the side effects, etc.) is readily available.

Referring to the main menu shown in FIG. 4 a user of the system may activate the “encyclopedia” button 25. When opening the encyclopaedia, the following information that has been pre-stored on the storage device 1, may be made available to the owner of the storage device and/or to the other users of the storage device:
Dangerous substances
Addresses
Medical terms
Internet links

Regarding a selected dangerous substance, an advice notice may be given on the most safe action(s) that has (have) to be taken. When a selection is made, people can see whether the victim has to bring up the substance, drink milk, drink water or do nothing. Does the victim need to be brought to the hospital or not, etc. The second part of the encyclopaedia is the address book. Here addresses of medical/health involved institutions and medical/health involved persons can be entered. The third part of the encyclopedia is the medical terms book. The meaning of thousands medical expressions is explained. The last function of the encyclopedia is a links field. By categorised groups the user can browse through medical and health related organisations, institutions and websites.

Referring to the main menu shown in FIG. 4, a user of the system may activate the “change language” button 26. Activating this button will cause the processing device to translate the language of the pre-stored texts in the windows of the system.

FIG. 12 shows a further preferred embodiment of a portable electronic storage device according to the invention. In this embodiment the electronic storage device is integrated in a mobile phone 51, for example a GSM-telephone. The mobile phone comprises a battery-(54) powered micro-controller (CON) 53 that is connected through a data bus 59 with a memory 52. On memory 52 is stored the software and data normally present for operating the mobile phone and the control software 15 and encryption software 16 and the medical database 17 according to the present invention. In another embodiment (not shown) the software 15, 16 and database 17 are stored on a separate memory device, for example a memory stick, that can be coupled to the mobile phone. Keyboard 56 may be used for controlling the software 15 and entering data into the database 17, while the standard display 55 can be used to display processed data from the medical database 17. The mobile phone further comprises a transceiver 60 connected to the antenna 58 for communication with the mobile telephone network. The mobile phone 51 also comprises a second transceiver for short-distance communication, for according to the Bluetooth™ protocol. Communication with a data processing device 2-6 is established in a wireless manner using the first transceiver 60, or, preferably, the second transceiver 61.

Concerning security, integrity and control of the database and the information contained in the database the following remarks can be made. The access to the medical/health data/information is secured with a username and a password. The owner has to log in before the data/information is accessible. Also the data inside the database is encrypted. Medical records such as medical dossiers, dental records and therapies are protected with a username and password of the owner (which is the healthcare professional). Only the proprietor of a particular record can change the contents by adding, modifying or removing data, or the entire record. In this way, the authenticity of the entered data is guaranteed. For instance, if the healthcare professional is permitted by the owner(s) of the storage device to create and open records, then this particular healthcare professional is the only individual that is permitted to control the contents of these records. However, reading the data in this record is possible for at least the owner or owners of the storage device l and possibly for other persons or institutions as well. Moreover, the owner(s) of the storage device 1 is(are) given the opportunity to add comments to every medical record.

In principle, the entire database can only be accessed by the patient (the owner or owners in case one storage device is used by two or more patients) of the storage device. The patient is asked to select the proper user (or create a new user) and to enter a password. Only with that password, his/her medical dossier can be opened. In this way the patient remains in full control of the access to his or her data/information.

The present invention is not limited to the above described preferred embodiments thereof; the rights sought are defined in the following claims, within the scope of which many modifications can be envisaged.

1. System for storing and exchanging medical data representative of the health of an individual, the system comprising:
a plurality of portable electronic storage devices, each storage device comprising an interface and one or more data carriers on which are stored medical data representative of the health of at least one individual, a first computer program and a second computer program;
a data processing device comprising:
a second interface for connecting the data processing device to at least one of the portable electronic storage devices,
a processor configured so as to load from the connected portable electronic storage device either the first or the second computer program depending on the type of data processing device and executing the same, the loaded computer program including instructions that cause the processor to process the medical data stored on the portable storage device, said processing including reading, adding and modifying medical data stored on the connected portable electronic storage device;
a display device for displaying said processed medical data;
wherein the first computer program is operable so as to exchange medical data with a data processing device of a first type en the second computer program being operable so as to exchange medical data with a data processing device of a different type.

2. System as claimed in claim 1, wherein the medical data include text data and graphical data, for instance X ray plots, scans plots or electro-cardiograms.

3. System as claimed in claims 1 or 2, wherein on the electronic storage device graphical data representative of the appearance of the individual is stored and wherein the processor is programmed so as to load the graphical data from the connected electronic storage device and to display the data representative of the appearance of the individual on the display device of the processing device so as to enable positive identification of the individual.

4. System as claimed in claim 1, wherein the electronic storage device is configured so as to provide access code protected access to the medical data stored thereon, wherein, depending on the access code, reading, adding and/or modifying rights are conferred for predefined subsets of medical data only.

5. System as claimed in claim 4, wherein one of the predefined subsets of medical data is formed by emergency medical data.

6. System as claimed in claim 1, comprising a first portable electronic storage device being configured so as to store thereon medical data in a first data format and a second portable electronic storage device being configured so as to store thereon medical data in a second data format, different from the first format.

7. System as claimed in claim 6, wherein on the first portable electronic storage device a first computer program is stored capable of having processed medical data in the first format, while on the second portable electronic storage device a second computer program is stored capable of having processed medical data in the second data format.

8. System as claimed in claim 1, wherein access to the medical data on the electronic storage device is protected by an access code, preferably a password.

9. System as claimed in claim 8, wherein a first user or group of users has data reading rights only.

10. System as claimed in claim 8 or 9, wherein a second user or second group of users has reading and adding rights only.

11. System as claimed in claim 10, wherein a third user or third group of users has reading, adding and modifying rights of medical data stored or to be stored on the electronic storage device.

12. System as claimed in claim 11, wherein the reading, adding and/or modifying rights are for a predefined subset of medical data only.

13. System as claimed in claim 1, wherein computer program is operable so as to permit the addition of a new user or group of users only after receiving the correct access code of said individual.

14. System as claimed in claim 1, wherein the computer program is operable so as to permit access to a predefined portion of the medical data only after receiving the correct access code of said individual.

15. System as claimed in claim 1, wherein the processing device includes an entering device for entering data into the computer device and storing the entered data on the electronic storage device.

16. System as claimed in claim 1, wherein the processing device is a mobile phone and the electronic storage device is an external storage medium that can be connected to the mobile phone.

17. System as claimed in claim 1, wherein the processing device is a mobile phone and the electronic storage device is an internal storage medium contained in the mobile phone.

18. System as claimed in claim 1, wherein the data processing device is a personal computer.

19. System as claimed in claim 1, wherein a portable electronic storage device is configured so as to be implanted in a person.

20. System as claimed in claim 1, wherein the electronic storage device comprises a positioning system.

21. System as claimed in claim 1, wherein the electronic storage device is configured so as to store non-medical personal data.

22. System as claimed in claim 1, wherein at least part of the medical and/or health data stored on the electronic storage medium is encrypted.

23. System as claimed in claim 1, wherein the first and second interface are wireless communication devices so as to provide a wireless connection between the portable electronic storage device and the data processing device.

24. System as claimed in claim 1, wherein the first and second interface are wired communication devices so as to provide a wired connection between the portable electronic storage device and the data processing device.

25. System as claimed in claim 1, wherein the computer program is operable so as to provide text on the display device in one of a plurality of languages, said one language being user selected from a pre-stored list of languages

26. Portable electronic storage device for storing and exchanging medical data with a data processing device having an interface, a processor and a display device, wherein the portable electronic storage device comprises a data carrier on which is stored medical data representative of the health of at least one individual, a first and a second computer program, wherein either of the computer programs, when run on said processor, causes said processor to process the medical data stored on the data carrier, said processing including reading, adding and/or modifying medical data stored on the connected portable electronic storage device, and displaying said processed data on the display device.

27. Method of storing and exchanging medical data using the system as claimed in claims 1, 2, 13, 14, 15, 16, 17, 18 or 25.
